(19) United States
(12) Patent Application Publication
(10) Pub. No.: US 2006/0223030 A1
(43) Pub. Date: Oct. 5, 2006

(54) Helical dental implant

(76) Inventor: Wolfgang Dinkelacker, Sindelfingen (DE)

Correspondence Address: KUDIRKA & JOBSE, LLP, ONE STATE STREET, SUITE 800, BOSTON, MA, 02109, US

(21) Appl. No.: 11/389,788

(22) Filed: Mar. 27, 2006

(30) Foreign Application Priority Data
Apr. 5, 2005 (DE) 20 2005 005 421.6

(51) Int. Cl. A61C 8/00

(52) U.S. Cl. 433/174

(57) ABSTRACT

A helical dental implant has a multi-turn thread around the periphery of the implant body, the thread turns of which body have a variable depth which varies continuously around the periphery of the implant body. The depth of the thread turns runs around the periphery of the implant body in an undulating manner at least once from a minimum depth to a maximum depth, and from there back to a minimum depth. The profile of the thread turns is adapted in its dimension to the size of the osteons of the jaw bone fixed to the implant surface. The implant body has a profiled implant head, a cylindrical thread section and a conical thread section which is designed as self-tapping.

### RELATED APPLICATIONS

This application claims priority under 35 U.S.C. §119 to German Application number DE 20 2005 05 421.6 which was filed on Apr. 5, 2005 by Wolfgang Dinkelacker entitled “Helical Dental Implant”.

### FIELD OF THE INVENTION

The invention relates to dental implant that can be screwed operatively into the human bone, with a cylindrical implant body which has a fine pitch thread on its periphery.

### BACKGROUND OF THE INVENTION

Bone implants with a helical implant body, which are screwed into a suitably dimensioned hole in the human bone, are known in the prior art. The hole is dimensioned according to the core diameter of the screw thread so that screwing in the implant ensures that it is firmly anchored in the bone. This operation is facilitated if the screw thread is of a self-tapping design. For this purpose cutting edges are worked into the screw thread so that it acts in the manner of a screw tap. Such implants may preferably be designed as jaw implants (e.g. EP 1 234 550 Al).

Furthermore, a helical bone implant whose screw thread has grooved recesses arranged in the thread turn is of prior art (WO 2004/098442 Al). The size of the grooved recesses is adapted to the size of the osteons of the bone tissue supported on the grooved recesses. The grooved recesses preferably run in a direction which corresponds essentially to the direction of the thread turn. They form a micro-thread superimposed on the screw thread, which micro-thread enlarges the contact surface between the implant and the bone tissue and supports the fixing of the osteons on the surface of the implant screwed into the bone.

In the field of helical dental implants it is also known to provide axially running channels distributed around the periphery of the implant body for improved anchoring of the implant in the jawbone, which channels interrupt the thread flanks and divide them into segments (U.S. Pat. No. 5,427,527), or for providing in a threaded section of the implant body, on the thread flanks, a plurality of flattened areas which are distributed round the periphery of the threaded section and provide space for the fixing of bone material (DE 20 2004 018 855).

It is further known to provide the surface of a dental implant with a plurality of grooved recesses running in the direction of its longitudinal axis or at an acute angle to it, which recesses are inclined radially to the surface of the implant body and which vary in depth along its length (DE 201 13 183.8). The grooved recesses are wedge-shaped or rhomboid at their base and facilitate the fixing of the osteons of the bone tissue onto the surface of the implant.

### SUMMARY OF THE INVENTION

The anchorage of a helical dental implant in the jawbone is further improved by this invention.

According to the invention, as defined in the claims, the implant body has a threaded periphery in which the thread height varies at different positions around the periphery of the implant body.

In a preferred embodiment, the thread height varies continuously around the periphery of the implant body starting from a minimum height and rising to a maximum height, and decreasing back to a minimum height. The height of the thread may vary over 180 degrees of the periphery of the implant body once from the minimum height to the maximum height and from there back to the minimum height.

According to an embodiment of the invention, the thread heights are varied around the periphery of the implant body so that along the longitudinal axis of the implant body thread teeth having the greatest thread height alternate with thread teeth having the smallest thread height.

The thread is preferably a trapezoidal thread that makes several turns around the implant body, in which both the thread height and pitch vary around the periphery of the implant body so that along the longitudinal axis of the implant body thread teeth having the greatest thread height and pitch alternate with thread teeth having the smallest thread height and pitch. The depth and width of the thread turns varies over 180 degrees of the periphery of the plant body once from the minimum depth to the maximum depth, and from there back to the minimum depth.

According to a further design of the invention the profile is adapted in its dimension to the range of sizes of the osteons fixed onto the implant surface.

Dental implants with a screw thread have the advantage that they prevent or at least make difficult the spread of tissue infections in the direction of the implant, head. This effect is combined according to the invention with the effect produced by the thread turns of variable depth and width, that of facilitating and promoting the fixing of the bone cells. This effect results from the inherent behaviour of the bone cells, particularly the osteons, that are fixed more effectively on the thread turns designed according to the invention, of variable depth, than is the case with conventional threads. Fast, lasting osteo-integration of the implants is achieved by the invention.

### BRIEF DESCRIPTION OF THE DRAWINGS

The above and further advantages of the invention may be better understood by referring to the following description in conjunction with the accompanying drawings in which:

FIG. 1 shows the side view of an embodiment of a helical dental implant according to the invention;

FIG. 2 shows a sectional view along line A-A in FIG. 1;

FIG. 3 shows a representation of the implant head in direction F in FIG. 1;

FIG. 4 shows an enlarged sectional view along line C-C in FIG. 1;

FIG. 5 shows an enlarged sectional view along line B-B in FIG. 1;

FIG. 6 shows an enlarged detail view of the thread profile at G in FIG. 2;

FIG. 7 shows an enlarged sectional view along line D-D in FIG. 1;

FIG. 8 shows an enlarged sectional view along line E-E′ in FIG. 1; and

FIG. 9 shows an enlarged detail view of the thread profile at H in FIG. 2.

### DETAILED DESCRIPTION

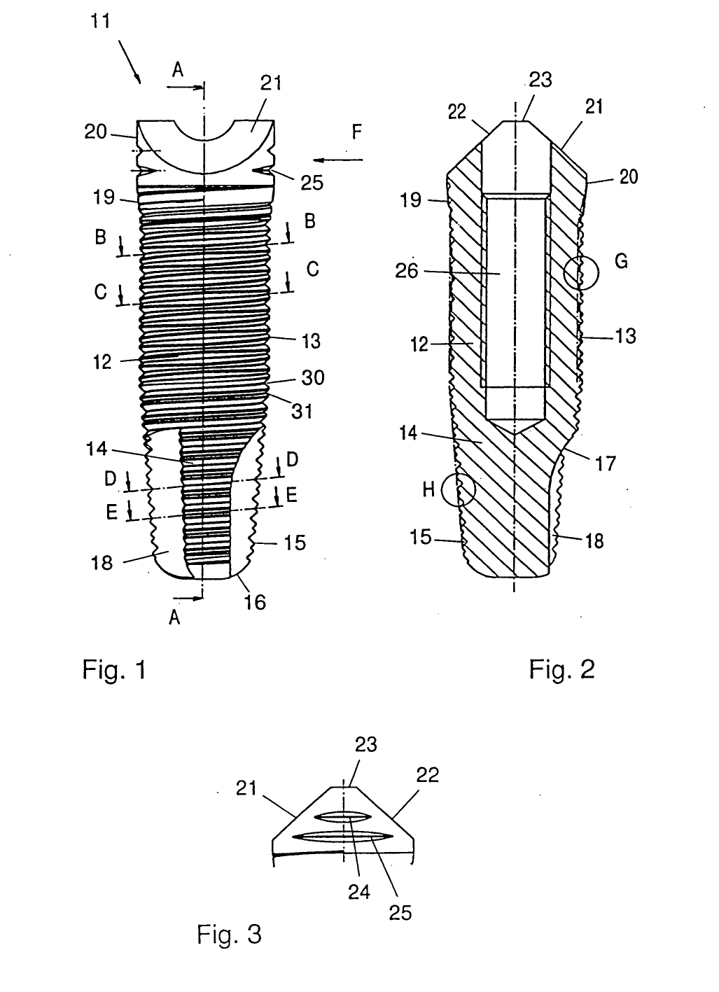

The dental implant shown in FIG. 1 comprises an implant body 11, which is designed as a self-tapping screw. Implant body 11 has a cylindrical central threaded section 12 which has a fine pitch male thread 13. A conical threaded section 14 is connected to cylindrical threaded sections 12 in the apical direction, over which section implant body 11 is reduced and also has a screw thread 15 on its periphery. The implant body is rounded at its apical end 16. Conical section 14 is designed as a self-tapping screw in a manner of prior art, for which purpose implant body 11 has three recesses 17 running in the axial direction and offset by 120 degrees in the region of threaded section 14, each of which recesses is limited by a cutting edge 18 acting in the direction of screwing in.

The diameter of implant body 11 is enlarged at the other end of cylindrical threaded section 12 by a short conical transition section 19 passing to a cylindrical implant head 20, which forms the crestal termination of implant body 11. Implant head 20 has a profile in the form of two opposing bevels 21, 22 and a roof surface 23 enabling the implant head to be adapted to the anatomy of the alveolar crest. In the region between bevels 21, 22 are arranged grooves 24, 25, which extend over the periphery of implant head 20 and open into the periphery of implant head 20 before bevels 21, 22. As indicated in FIG. 3, grooves 24, 25 have different lengths because of the roof-shaped profile of implant head 20.

The surface of implant body 11 is designed so that it is biocompatible, and can be provided by surface treatment with a micro-roughness which facilitates the integration of the implant in the bone tissue of the jawbone and gingival tissue. The surface of implant body 11 may be coated with a biocompatible material in regions that come into contact with bone tissue or soft tissue, or can be treated by acid etching or sandblasting. The regions treated may also be covered by a sputter coat consisting preferably of titanium. The surface treatment may be extended to implant head 20, opposing bevels 21, 22 and roof surface 23 remaining untreated.

Implant body 11 is provided with a central threaded hole 26 in which engages a screw by means of which an implant attachment, not shown, is connected to implant body 11. The implant attachment serve.s as a support for a tooth crown or another denture. The screw and the implant attachment are not shown in the drawings. Implant body 11 preferably consists of titanium or a titanium alloy, ceramic or another material of sufficient hardness compatible with the jaw bone tissue.

Thread 13 on the periphery of cylindrical section 12 has multiple thread turns which run out into the short conical transition section 19. The thread turns have a variable depth along their length. The depth of the thread turns runs in undulating fashion around the periphery of implant body 11. The depth of the thread turns varies around the periphery of the implant body at least twice continuously, from a minimum depth to a maximum depth, and from there back to a minimum depth. Correspondingly the course of the depths around the implant body periphery and over 360 degrees of the implant body periphery forms two wave valleys and two wave crests. Here the adjacent thread turns are offset 90 degrees to each other so that the wave valley of one thread turn lies adjacent to a wave crest of the adjacent thread turn.

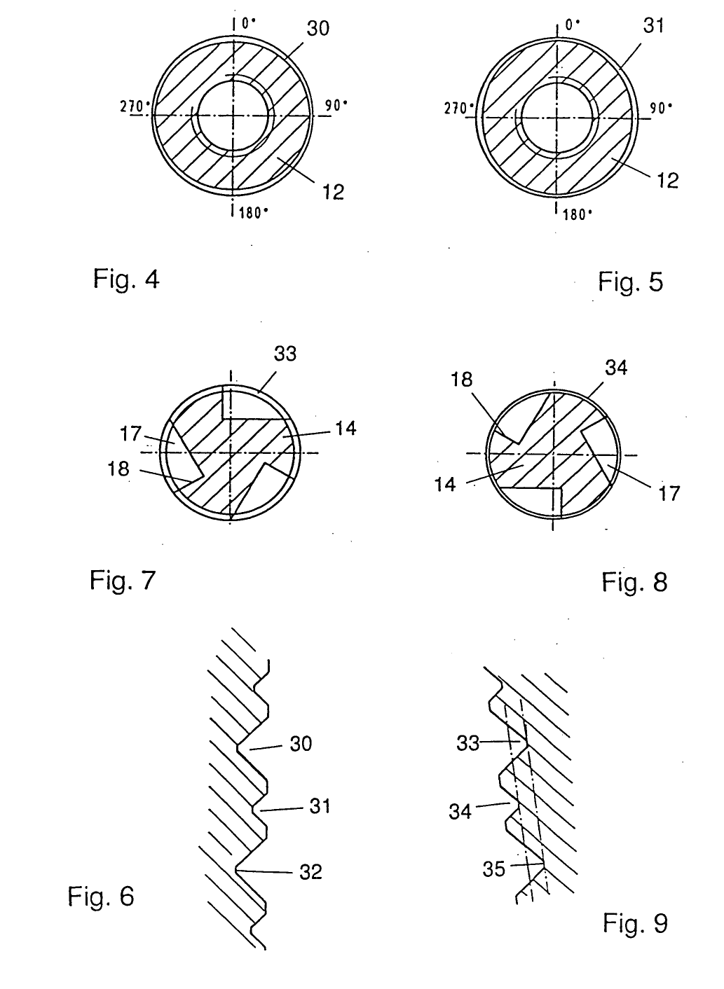

An embodiment of this course of threads is shown in the figures. Cylindrical section 12 of implant body 11 has a two-pitch thread with thread turns 30, 31. The sectional view in FIG. 4 shows the course of depths of the first thread turn 30 around the periphery of implant body 11. First thread turn 30 has its greatest depth at 0 degree. The depth is reduced to its lowest value at 90 degrees, then increases to its maximum value at 180 degrees, from where it is again reduced to its lowest value at 270 degrees. FIG. 5 shows the course of depths of the adjacent second thread turn 31 around-the periphery of implant body 11. The second thread turn exhibits its smallest depth at 0 degree. The depth increases to its maximum value at 90 degrees, then decreases back to its minimum value at 270 degrees. In the course of both thread turns 30, 31 through to-e periphery of implant head 11, regions of maximum depth are therefore adjacent to regions of minimum depth.

In the embodiment shown thread 13 has a uniform flank angle in both ,thread turns 30, 31. As the depth of thread turns 30, 31 varies, so does their width. FIG. 6 shows the profile of thread turns 30, 31. FIG. 6 shows thread turns 30, 31 in relation to FIGS. 4 and 5 at 0 degree, where thread turn 30 has its greatest depth and width, whilst adjacent thread turn 31 has its smallest depth and width at 0 degree.

The thread of implant body 11 is a fine pitch thread in which the dimension of the thread turns is adapted to the size of the bone cells fixed to implant body 11. The radially inclined course of the thread turns resulting from the depths of the thread turns that vary according to the invention facilitates the fixing of the bone cells and provides fast, permanent anchorage of the implant in the jaw bone.

The depth of the thread turns ranges from 10 to 200 micrometres, i.e. their maximum depth is up to 200 micrometres and their minimum depth at least 10 micrometres. In the embodiment shown in FIGS. 7-9 a depth range of 70-150 micrometres is preferred for thread turns 30, 31, for which the maximum depth is 150 micrometres and the maximum depth 70 micrometres. The flank angle of thread turns 30, 31 ranges from 80 to 90 degrees, and for the trapezoidal profile in the embodiment shown a flank angle of 88 degrees is preferred. The profile of thread turns 30, 31 is provided with a narrow base area 32, which is aligned parallel with the implant axis and which has an extension of preferably 30 micrometres. Because of the dimensioning of thread turns 30, 31 provided in the embodiment, these are adapted to the range of sizes of the thread-like osteons whose diameter ranges between 20 and 300 micrometres.

Thread 15 of the conical section has the same pitch as thread 13 of the cylindrical section and is also a two-pitch thread with thread turns 33, 34. However, thread 15 has a different structure from thread 13. Each of the two thread turns 33, 34 has a uniform depth along their length and adjacent thread turns have different depths. Just as thread 13, thread 15 is also adapted to the size of the bone cells fixed to implant body 11. The depth of thread turns ranges from 50-200 micrometres. In the embodiment shown the first of the two thread turns 33, 34 has a depth of 154 micrometres, and the second of these thread turns has a depth of 75 micrometres. Thread turns 33, 34 also have a trapezoidal profile whose flank angle ranges from 80 to 90 degrees. In the embodiment shown a flank angle of 88 degree is preferred. Furthermore, thread turns 33, 34 have a base area 35 of preferably 30 micrometres. Thus thread turns 33, 34, as also thread turns 31, 32, lies within the range of sizes of the osteons.

Whilst the invention has been described with reference to a preferred embodiment, modifications and other designs may be realised without this departing from the scope of the invention defined by the claims. For example, threads 13 and 15 may, instead of two turns, have a large number of thread turns, or may also be designed as a single pitch thread. If more than two thread turns are used, deep thread turns may be arranged in conical section 14 alternating with flatter thread turns. Furthermore, threads 13 and 14 may have a different profile and may be designed, for example, as an angular or round thread. The dimensions of the thread turns may also deviate from the dimensions indicated above.

What is claimed is:

1. A dental implant with an implant body which has at least over a part of its periphery a cylindrical shape and which has at its periphery a screw threat to allow implanting by screwing the implant body into an opening of the jaw bone, the screw threat comprises a fine pitch thread of at least one single thread turn, the thread turn comprising along its length a variable depth which continuously runs between portions of small depth and portions of greater depth.

2. The implant according to claim 1, wherein the depth of the thread turn varies around the periphery of the implant body in an undulating fashion at least one time over 360 degree of the implant body periphery from a minimum depth to a maximum depth, and from there back to a minimum depth.

3. The implant according to claim 2, wherein the depth of the thread turn continuously varies over 180 degrees of the periphery of the implant body once from the minimum depth to the maximum depth, and from there back to the minimum depth.

4. The implant according to claim 1, wherein along the length of the thread turn regions of maximum depth are adjacent to regions of minimum depth in the course of the thread turn around the periphery of the implant body.

5. The implant according to claim 1, wherein the thread is a trapezoidal thread.

6. A dental implant with an implant body which has at least over a part of its periphery a cylindrical shape and which has at its periphery a screw thread to allow implanting by screwing the implant body into an opening of the jaw bone, the screw threat is a multiple threat of fine pitch, each one of the multiple thread comprising along its length over the implant body a variable depth which continuously runs between regions of small depth and regions of greater depth.

7. The implant according to claim 6, wherein a first thread of the multiple threat comprising regions of maximum depth and width which are adjacent to regions of minimum depth and width of a second thread of the multiple threat which second thread is adjacent to the first threat.

8. The implant according to claim 6, wherein the depth and width of each thread of the multiple threat vary over 180 degrees of the periphery of the implant body continuously once from the minimum depth and width to the maximum depth and width, and from there back to the minimum depth and width.

9. The implant according to claim 6, wherein the multiple thread comprises two threads.

10. The implant according to claims 1 or 6, wherein the profile of the threads is adapted in its dimension to the range of sizes of the osteons of the bone tissue which deposit to the implant surface.

11. The implant according to claims 10, wherein the depth of each thread ranges from 10 to 200 micrometers.

12. The implant according to claim 10, wherein the depth of each thread ranges from 50 to 150 micrometers.

13. The implant according to claims 1 or 6, wherein the flank angle of the thread profile ranges from 80 to 90 degrees.

14. A dental implant with an implant body having a cylindrical section which is provided at its periphery with a fine pitch thread of at least one single thread turn comprising along its length over the implant body a variable depth which continuously runs between regions of small depth and regions of greater depth; the implant body comprising a conical thread section which is connected to the cylindrical threaded section in apical direction and which is designed to be self-tapping; and the implant body further comprising a conical transition section which is connected to the cylindrical threaded section in crestal direction and into which the at least one single thread turn runs out and which forms the transition to an implant head.

15. The implant according to claim 14, wherein the apical conical section has around its periphery a screw thread with essentially the same pitch and same number of threads as the screw thread of the cylindrical section.

16. The implant according to claim 14, wherein the screw thread of the apical conical section comprises threads of uniform depth along its length, and wherein adjacent threads are different in their depth.

17. The implant according to claim 14, wherein the implant body has a profiled implant head with bevels on opposite sides.

18. The implant according to claims 14, wherein the implant head is designed around its periphery as a cylinder being connected to the conical transition section and comprising grooves in the region between the bevels which grooves run transversely to the implant axis.

19. The implant according to one of claims 14, wherein the implant body comprises a biocompatible surface.
